(19) United States
(12) Patent Application Publication
(10) Pub. No.: US 2011/0052290 A1
(43) Pub. Date: Mar. 3, 2011

(54) IMAGE FORMING APPARATUS, METHOD OF CONTROLLING IMAGE FORMING APPARATUS AND RECORDING MEDIUM

(75) Inventor: Tsuyoshi Kurakata, Kawasaki-shi (JP)

(73) Assignee: CANON KABUSHIKI KAISHA, Tokyo (JP)

(21) Appl. No.: 12/850,953

(22) Filed: Aug. 5, 2010

(30) Foreign Application Priority Data
Aug. 31, 2009 (JP) 2009-201081

(51) Int. Cl. G03G 15/00

(52) U.S. Cl. 399/388

(57) ABSTRACT

When executing the second image forming process for a sheet having undergone the first image forming process, feeding of the sheet for an image forming process different from the second image forming process needs to be prevented. To accomplish this, an image forming apparatus includes a control unit that executes the first image forming process to form an image on a sheet fed from one of feeding units, and a designation unit that designates, from the plurality of feeding units, a feeding unit used for the second image forming process to be executed for the sheet having an image formed in the first image forming process executed by the control unit. When the sheet is set in the feeding unit designated by the designation unit, the control unit restricts feeding of the set sheet for an image forming process different from the second image forming process.

### BACKGROUND OF THE INVENTION

1. Field of the Invention

The present invention relates to an image forming apparatus, a method of controlling an image forming apparatus and a recording medium.

2. Description of the Related Art

Recently, there is known an image forming apparatus such as a copying machine which forms an image using a special toner such as a transparent (CL) toner in addition to four, cyan (C), magenta (M), yellow (Y), and black (K) color toners. An image forming apparatus of this type can adjust the glossiness of the printed surface of a sheet by further forming an image using the transparent toner on a sheet bearing an image formed using the four, C, M, Y, and K color toners.

As a method of performing an image forming process using a transparent toner in an image forming apparatus, for example, Japanese Patent Laid-Open No. 2004-128911 discloses a method of printing by one image forming process using five, C, M, Y, K, and CL toners when executing an image forming process using the transparent toner. More specifically, a feeding unit feeds a sheet, an image is formed using the five toners on the fed sheet, and the sheet is discharged. This image forming process is executed once, obtaining an output result.

Another method forms an image by two image forming processes. First, the user causes an image forming apparatus to execute the first image forming process using the four, C, M, Y, and K color toners. Then, he sets, again in the feeding unit, the sheet bearing the image formed in the first image forming process. The user sets to execute the second image forming process using the transparent toner, and causes the image forming apparatus to execute the image forming process.

The amount of toner applicable to a sheet by the first image forming process is restricted by the amount of toner fixable at once by the fixing unit of the image forming apparatus. Hence, the amount of toner applicable to a sheet can be increased by performing two image forming processes, compared to applying the five toners to a sheet in one image forming process.

However, the following problem arises when forming an image in two image forming processes. A sheet bearing an image formed in the first image forming process is set again in the feeding unit. However, till the start of the second image forming process, another image forming process may use the sheet set in the feeding unit. For example, if an image corresponding to another print job is formed on a sheet printed in the first process, a printed product the user does not want is output.

### SUMMARY OF THE INVENTION

The present invention has been made to solve the above problems. The present invention provides a mechanism for preventing, when executing the second image forming process for a sheet having undergone the first image forming process, the use of the sheet for an image forming process different from the second image forming process.

One aspect of the present invention provides an image forming apparatus comprising: a control unit that executes a first image forming process to form an image on a sheet fed from one of a plurality of feeding units; and a designation unit that designates, from the plurality of feeding units, a feeding unit used for a second image forming process to be executed for the sheet having an image formed in the first image forming process executed by the control unit, wherein when the sheet is set in the feeding unit designated by the designation unit, the control unit restricts feeding of the set sheet for an image forming process different from the second image forming process.

Another aspect of the present invention provides a method of controlling an image forming apparatus, comprising: causing a control unit to execute a first image forming process to form an image on a sheet fed from one of a plurality of feeding units; and causing a designation unit to designate, from the plurality of feeding units, a feeding unit used for a second image forming process to be executed for the sheet having an image formed in the first image forming process executed in the causing a control unit to execute a first image forming process, wherein in the causing a control unit to execute a first image forming process, when the sheet is set in the feeding unit designated in the causing a designation unit to designate a feeding unit, feeding of the set sheet for an image forming process different from the second image forming process is restricted.

When executing the second image forming process for a sheet having undergone the first image forming process, the present invention can prevent the use of the sheet for an image forming process different from the second image forming process.

Further features of the present invention will become apparent from the following description of exemplary embodiments (with reference to the attached drawings).

### BRIEF DESCRIPTION OF THE DRAWINGS

FIG. 1 is a block diagram exemplifying a network configuration including an image forming apparatus 100 according to an embodiment of the present invention;

FIG. 2 is a sectional view exemplifying the hardware arrangement of the image forming apparatus 100 according to the embodiment of the present invention;

FIG. 3 is a sectional view exemplifying the hardware arrangement of a printer unit 130 in the image forming apparatus 100 according to the embodiment of the present invention;

FIG. 4 is a block diagram exemplifying the arrangement of a control unit 110 in the image forming apparatus 100 according to the embodiment of the present invention;

FIG. 5 is a view showing an image data processing sequence in the image forming apparatus 100 according to the embodiment of the present invention;

FIG. 6 is a view exemplifying a setting screen 600 regarding image formation using a transparent toner according to the embodiment of the present invention;

FIG. 7 is a table exemplifying setting data 700 regarding image formation using the transparent toner according to the embodiment of the present invention;

FIG. 8 is a view exemplifying a printed product in image formation using the transparent toner according to the embodiment of the present invention;

FIG. 9 is a flowchart showing the sequence of a printing process using the transparent toner according to the embodiment of the present invention;

FIG. 10 is a view exemplifying a setting screen displayed on an operation unit 140 according to the embodiment of the present invention;

FIG. 11 is a view exemplifying a setting screen displayed on the operation unit 140 according to the embodiment of the present invention;

FIG. 12 is a view exemplifying an instruction screen displayed on the operation unit 140 according to the embodiment of the present invention; and

FIG. 13 is a view exemplifying a screen which displays the status of a job input to the image forming apparatus 100 according to the embodiment of the present invention.

### DESCRIPTION OF THE EMBODIMENTS

A preferred embodiment of the present invention will be described below. The embodiment to be described below would help understand various concepts such as superordinate, intermediate, and subordinate concepts of the invention. The technical scope of the present invention is defined by the scope of the claims, and is not limited by the following embodiment.

<Arrangement of Image Forming Apparatus>

As an example of an image forming apparatus, the embodiment will explain an MFP (Multi Function Peripheral) having a plurality of functions such as a copy function and printer function. Note that the image forming apparatus may be an SFP (Single Function Peripheral) having only a copy function or printer function.

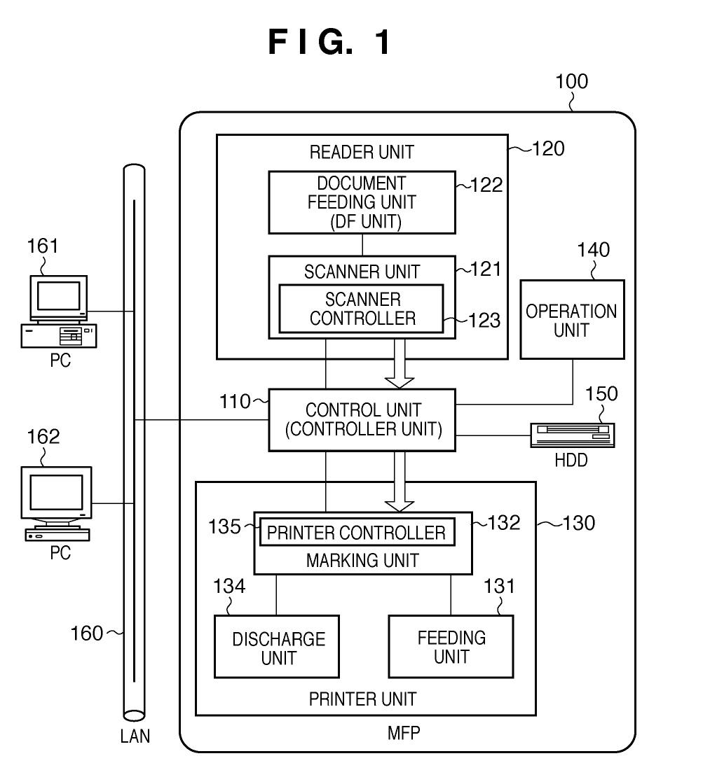

The arrangement of an MFP 100 will be exemplified with reference to FIG. 1. A controller unit (control unit) 110 is electrically connected to a reader unit 120 and printer unit 130. The control unit 110 receives data from the reader unit 120 and printer unit 130. The control unit 110 transmits various commands to the reader unit 120 and printer unit 130. Further, the control unit 110 is connected to PCs 161 and 162 via a network 160, and receives image data and control commands from them. The network 160 is formed from, for example, Ethernet®.

The reader unit 120 optically reads a document image, and converts it into image data. The reader unit 120 includes a scanner unit 121 having a function of reading a document, and a document feeding unit 122 which conveys a document to a position where the scanner unit 121 can read it. A scanner controller 123 of the scanner unit 121 controls the scanner unit 121 and document feeding unit 122 based on instructions from the control unit 110.

The printer unit 130 includes a feeding unit 131 which stores sheets (paper or printing materials) for image formation (printing), a marking unit 132 which transfers and fixes image data onto a sheet, and a discharge unit 134 which discharges a printed sheet. Based on an instruction from the control unit 110, the printer unit 130 feeds a sheet from the feeding unit 131 to the marking unit 132. The marking unit 132 prints image data on the sheet, and discharges the sheet to the discharge unit 134. The discharge unit 134 can perform processes such as sorting and stapling for the sheet printed by the marking unit 132. The feeding unit 131 includes a plurality of feeding units. Sheets are stored and set in each feeding unit. Each feeding unit can store a plurality of types of sheets such as plain paper and glossy paper. Each feeding unit can also store again a sheet printed by the printer unit 130 of the MFP 100. Examples of the feeding unit are a feeding cassette, feeding deck, and manual feeding tray. The form of the feeding unit is not limited to them as long as a stored sheet can be conveyed to the marking unit 132.

An operation unit 140 includes, for example, hard keys, a liquid crystal display, and a touch panel adhered to the surface of the liquid crystal display. The operation unit 140 accepts instructions from the user via these components. The operation unit 140 can display soft keys, and the functions and state of the MFP 100 on the liquid crystal display. The operation unit 140 transmits a command corresponding to an instruction from the user to the control unit 110. An HDD (Hard Disk Drive) 150 stores various settings and image data of the MFP 100.

With this arrangement, the MFP 100 implements a variety of functions such as a copy function, image data transmission function, and printer function. When implementing the copy function, the control unit 110 controls the reader unit 120 to read image data of a document, and the printer unit 130 to print on a sheet using the image data. When implementing the image data transmission function, the control unit 110 converts image data of a document read by the reader unit 120 into code data, and transmits the code data to the PC 161 or 162 via the network 160. When implementing the printer function, the control unit 110 converts code data (printing data) received from the PC 161 or 162 via the network 160 into image data, and transmits the image data to the printer unit 130. The printer unit 130 prints on a sheet using the received image data.

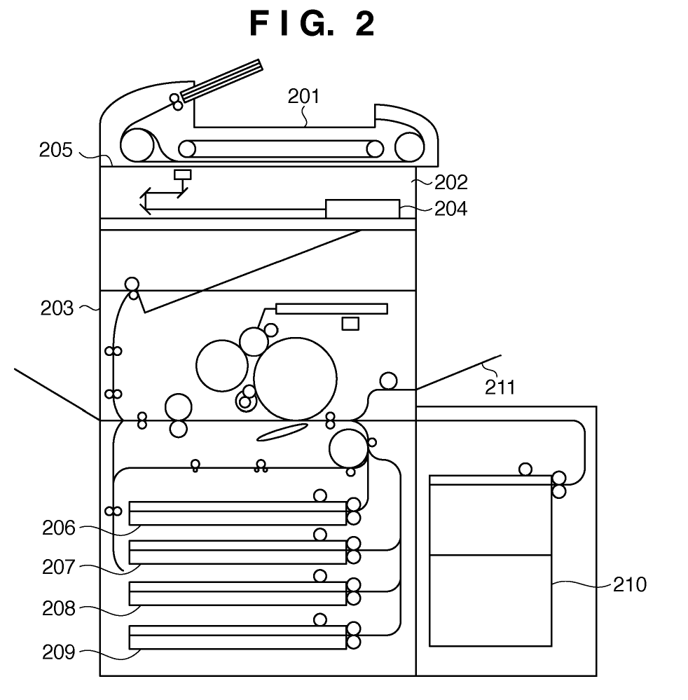

The hardware arrangement of the MFP 100 will be exemplified with reference to FIG. 2. As an example of the MFP 100, the embodiment will describe a one-drum color printer that performs color printing using a single drum. In FIG. 2, a document feeding unit 201, scanner unit 202, printer unit 203, and control unit 204 correspond to the document feeding unit 122, scanner unit 121, marking unit 132, and control unit 110 in FIG. 1.

The document feeding unit 201 conveys a document onto to a document glass 205 so that the document can be optically read. The scanner unit 202 transmits, to the control unit 204, an optical signal obtained by scanning a document image using an image reading sensor. The control unit 204 generates an image signal using the received optical signal. Based on the image signal generated by the control unit 204, the printer unit 203 prints on a sheet fed from the feeding unit. Note that the MFP 100 includes, as feeding units, feeding cassettes 206 to 209, a feeding deck 210, and a manual feeding tray 211. The printer unit 203 can feed a sheet from any feeding unit.

(Arrangement of Printer Unit 130)

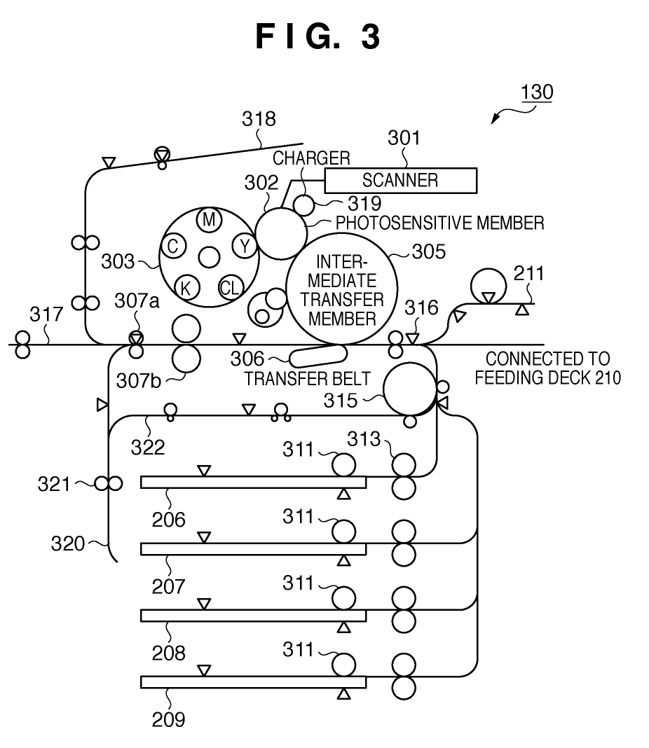

The hardware arrangement of the printer unit 130 will be exemplified with reference to FIG. 3. A printer controller 135 controls each unit of the printer unit 130. An image forming process for a sheet under the control of the printer controller 135 will be described briefly. The printer controller 135 rotates a photosensitive member 302 counterclockwise in FIG. 3 based on an instruction from the control unit 110. A charger 319 charges the surface of the photosensitive member 302. A laser driver 301 irradiates the photosensitive member 302 with a laser beam based on an image signal generated by the control unit 110, forming an electrostatic latent image on the surface of the photosensitive member 302.

Based on an instruction from the printer controller 135, a developer 303 develops the electrostatic latent image formed on the surface of the photosensitive member 302 using a plurality of color developing materials (toners). The toner image developed on the surface of the photosensitive member 302 is transferred to an intermediate transfer member 305 which rotates clockwise in FIG. 3. Note that the developer 303 includes developers corresponding to five toners, that is, yellow (Y), magenta (M), cyan (C), and black (K) colored toners and a transparent (CL) toner. For color printing in the one-drum MFP 100 shown in FIG. 3, images are transferred to the intermediate transfer member 305 sequentially for the respective colors. More specifically, toner images sequentially formed on the surface of the photosensitive member 302 by the developer 303 are superimposed and transferred at the same position on the intermediate transfer member 305 in synchronism with rotation of the intermediate transfer member 305. As a result, a 1-page color image is formed on the surface of the intermediate transfer member 305 using the Y, M, C, and K toners. When it is designated to print using the CL toner, a CL toner image may be transferred subsequently to transferring the Y, M, C, and K toner images.

While executing this image forming process, the printer controller 135 feeds a sheet from one of the feeding cassettes 206 to 209, feeding deck 210, and manual feeding tray 211. For example, when feeding a sheet from one of the feeding cassettes 206 to 209, the printer controller 135 operates a corresponding pickup roller 311. Feeding rollers 313 convey the fed sheet to the position of a conveyance roller 315. The conveyance roller 315 conveys the sheet up to a registration roller front position 316.

The printer controller 135 conveys the sheet to a position between the intermediate transfer member 305 and a transfer belt 306 at the timing when a color image transfer process for the intermediate transfer member 305 is completed. At this position, the transfer belt 306 transfers, to the sheet, the 1-page image formed on the intermediate transfer member 305. After the transfer process, the printer controller 135 conveys the sheet to fixing rollers 307a and 307b. The fixing rollers 307a and 307b heat and press the toner image to fix it onto the sheet. The printer controller 135 discharges the sheet to a face-up discharge port 317 or face-down discharge port 318.

In double-sided printing, the printer controller 135 conveys a sheet having undergone the fixing process to a reverse path 320. Reverse rollers 321 turn the sheet upside down, and the conveyance roller 315 conveys the sheet again to the registration roller front position 316 via a reverse surface path 322. By the same method as image formation for the first page (obverse surface) on one surface of the sheet, the printer controller 135 executes image formation on the second page (reverse surface) on the other surface of the sheet. Then, the printer controller 135 discharges the sheet bearing images on the two surfaces to the face-up discharge port 317 or face-down discharge port 318. By this operation, the image forming process (printing process) for the sheet is completed.

The control unit 110 performs this operation by executing a print job stored in the HDD 150. The print job is obtained by associating image data to be printed with data that sets printing conditions (for example, single/double-sided setting and printing layout setting) used to print the image data.

(Arrangement of Control Unit 110)

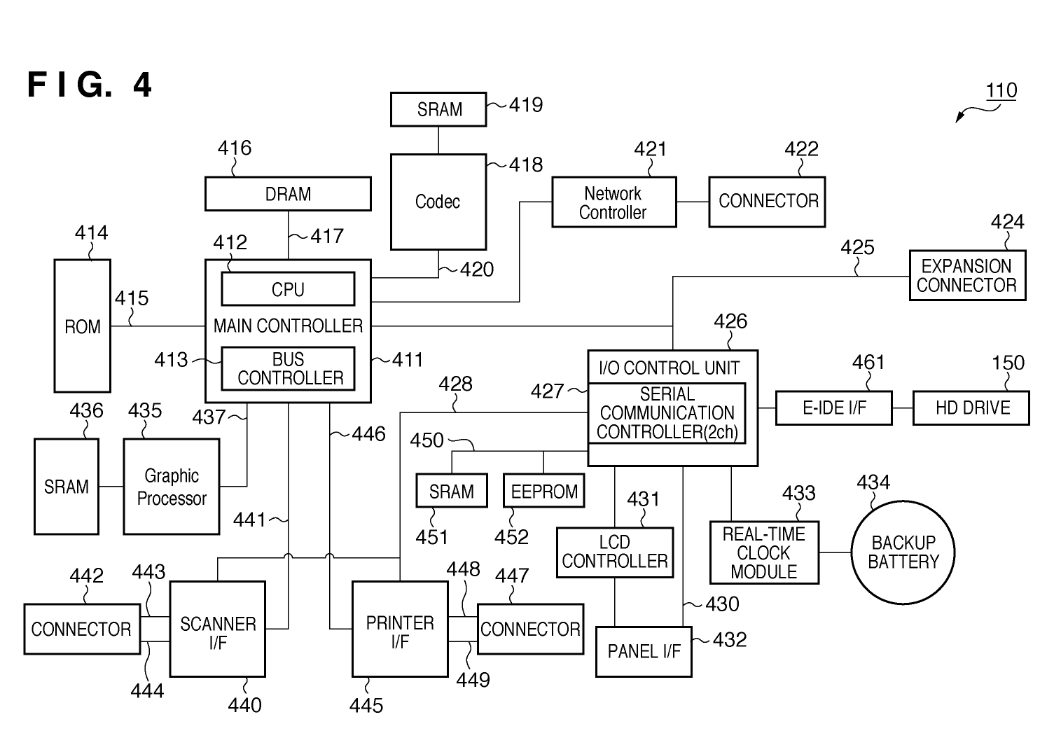

The block arrangement of the control unit 110 will be exemplified with reference to FIG. 4. A main controller 411 includes a CPU 412, bus controller 413, and various I/F controller circuits. The CPU 412 and bus controller 413 comprehensively control the operation of the whole control unit 110. The CPU 412 executes a variety of operations based on a program loaded from a ROM 414 via an ROM I/F 415. For example, based on the loaded program, the CPU 412 interprets code data (for example, PDL (Page Description Language)) received from the PC 161 or PC 162 shown in FIG. 1. The bus controller 413 controls data transfer via each I/F, for example, controls bus arbitration and DMA data transfer.

A DRAM 416 is connected to the main controller 411 via a DRAM I/F 417. The DRAM 416 is used as a work area for the operation of the CPU 412, and an area for accumulating image data. A codec 418 compresses raster image data accumulated in the DRAM 416 according to a scheme such as MH, MR, MMR, JBIG, or JPEG. Also, the codec 418 decompresses compressed/accumulated code data into raster image data. An SRAM 419 is used as the temporary work area of the codec 418. The codec 418 is connected to the main controller 411 via an I/F 420. Data transfer between the SRAM 419 and the DRAM 416 is controlled by the bus controller 413 and implemented by DMA transfer.

A graphic processor 435 performs processes such as image rotation, image scaling, color space conversion, and binarization for raster image data accumulated in the DRAM 416. An SRAM 436 is used as the temporary work area of the graphic processor 435. The graphic processor 435 is connected to the main controller 411 via an I/F 437. Data transfer between the graphic processor 435 and the DRAM 416 is controlled by the bus controller 413 and achieved by DMA transfer.

A network controller 421 is connected to the main controller 411 via an I/F 423 and an external network (for example, the network 160) via a connector 422. An expansion connector 424 for connecting an expansion board, and an I/O control unit 426 are connected to a general-purpose high-speed bus 425. The general-purpose high-speed bus 425 is, for example, a PCI bus. In the I/O control unit 426, an asynchronous serial communication controller 427 has two channels to transmit/receive control commands to/from the CPUs of the reader unit 120 and printer unit 130.

The I/O control unit 426 is connected to a scanner I/F 440 and printer I/F 445 via an I/O bus 428. A panel I/F 432 is used to transmit/receive data to/from the operation unit 140. The panel I/F 432 transfers image data from an LCD controller 431 to the operation unit 140. The panel I/F 432 transfers, to the I/O control unit 426 via a key input I/F 430, a key input signal input via the hard key or touch panel of the operation unit 140.

A real-time clock module 433 receives power from a backup battery 434, and updates and saves the date and time managed in the MFP 100. An E-IDE I/F 461 connects the HDD 150. The CPU 412 stores image data in the HDD 150 via the E-IDE I/F, and reads image data from the HDD 150.

Connectors 442 and 447 are connected to the reader unit 120 and printer unit 130, respectively. The connectors 442 and 447 are connected to the scanner I/F 440 and printer I/F 445 via asynchronous serial I/Fs 443 and 448, and video I/Fs 444 and 449, respectively.

The scanner I/F 440 is connected to the reader unit 120 via the connector 442, and the main controller 411 via a scanner bus 441. The scanner I/F 440 performs a predetermined process for an image received from the reader unit 120. The scanner I/F 440 outputs, to the scanner bus 441, a control signal generated based on a video control signal received from the reader unit 120. The bus controller 413 controls data transfer from the scanner bus 441 to the DRAM 416.

The printer I/F 445 is connected to the printer unit 130 via the connector 447, and the main controller 411 via a printer bus 446. The printer I/F 445 performs a predetermined process for image data output from the main controller 411, and outputs the processed image data to the printer unit 130. The bus controller 413 controls transfer of raster image data rasterized in the DRAM 416 to the printer unit 130. The raster image data is DMA-transferred to the printer unit 130 via the printer bus 446, printer I/F 445, and video I/F 449.

An SRAM 451 receives power from a backup battery and can keep holding stored contents even when the entire MFP 100 is turned off. The SRAM 451 is connected to the I/O control unit 426 via a bus 450. An EEPROM 452 is a memory that is also connected to the I/O control unit 426 via the bus 450.

<Image Forming Process Using Transparent Toner>

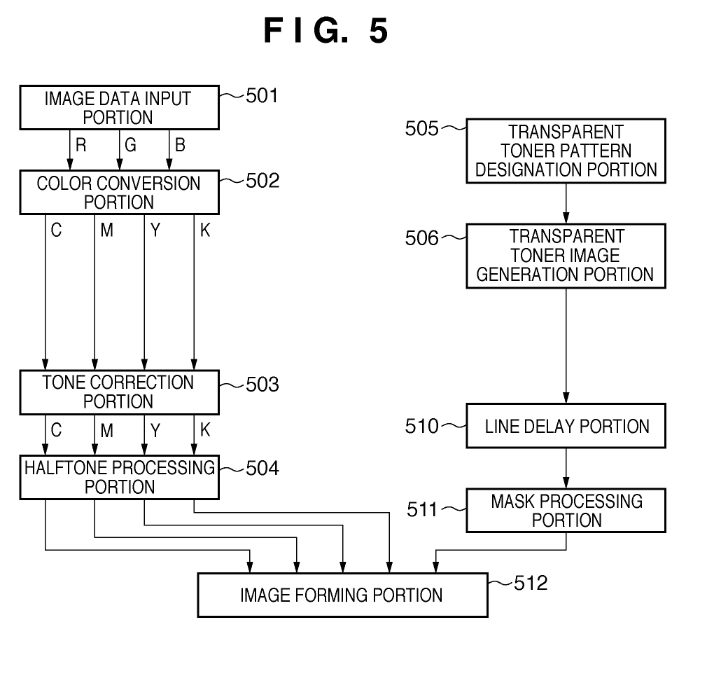

An image data processing sequence will be described with reference to FIG. 5. FIG. 5 shows functional blocks implemented by executing a program stored in the ROM 414 by the CPU 412 of the control unit 110, and a data flow. FIG. 5 shows an image data input portion 501, color conversion portion 502, tone correction portion 503, halftone processing portion 504, transparent toner image generation portion 506, line delay portion 510, and mask processing portion 511.

The image data input portion 501 receives image data obtained by reading a document by the reader unit 120, or image data received from the PC 161 or 162 via the network 160. The CPU 412 temporarily accumulates, for each page in the DRAM 416, the image data obtained by the reader unit 120. Then, the CPU 412 reads out the data for each pixel and inputs it to the image data input portion 501.

The image data input portion 501 divides the image data of each pixel input by the CPU 412 into R, G, and B image signals, and outputs them to the color conversion portion 502. The color conversion portion 502 converts the received R, G, and B image signals into C, M, Y, and K image signals corresponding to a printout color space, and outputs them to the tone correction portion 503. The tone correction portion 503 performs tone correction for the received image signals so as to obtain a normal tone characteristic, and outputs the resultant image signals to the halftone processing portion 504. The halftone processing portion 504 performs a pseudo halftone process for the image signals having undergone tone correction, and outputs the image signals to the printer unit 130.

In contrast, a transparent toner pattern designation portion 505 is arranged in the operation unit 140 or the PC 161 or 162. The transparent toner pattern designation portion 505 creates setting data regarding image formation using a transparent toner based on data input from the user, and inputs the setting data to a transparent toner image generation portion 506. In accordance with the setting data, the transparent toner image generation portion 506 generates bitmap image data to be output in image formation using a transparent toner. The transparent toner image generation portion 506 outputs the image data as an image signal of each pixel to the line delay portion 510. The line delay portion 510 delays an image signal contained in the received image data, and outputs the delayed image signal to the mask processing portion 511. The mask processing portion 511 performs a mask process for the received image signal, and outputs the resultant image signal to an image forming portion 512 (corresponding to the printer unit 130 in FIG. 1).

Based on the image signal received from the halftone processing portion 504 and that received from the mask processing portion 511, the image forming portion 512 prints C, M, Y, and K color images and a transparent toner image on a sheet.

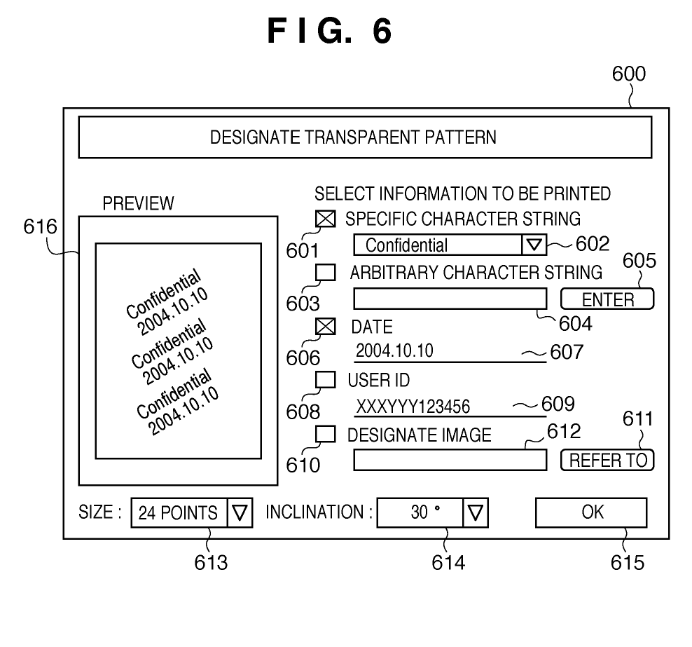

A setting screen 600 regarding image formation using the transparent toner will be exemplified with reference to FIG. 6. The transparent toner pattern designation portion 505 implemented by the CPU 412 displays the setting screen 600 on the operation unit 140. This screen appears on the operation unit 140 when the user presses a transparent toner print setting key (not shown) arranged on the operation unit 140. The CPU 412 accepts an input from the user via the touch panel attached to the operation unit 140. Note that the setting screen 600 may be displayed on the display device of the PC 161 or 162 under the control of a printer driver installed in the PC 161 or 162.

A check box 601 is used to set whether to print a specific character string using the transparent toner. When the user checks the check box 601, the CPU 412 sets to print a character string selected from a pull-down menu 602 using the transparent toner. Candidates selectable by the user using the pull-down menu 602 are character strings such as “Eyes-only” and “Copy Protected”, in addition to “Confidential” shown in FIG. 6.

A check box 603 is used to set whether to print an arbitrary character string using the transparent toner. When the user checks the check box 603, the CPU 412 sets to print an arbitrary character string input to a text box 604 using the transparent toner. The user can input a character string to the text box 604 using a software keyboard displayed on the operation unit 140. When the user presses an input button 605, the software keyboard appears on the operation unit 140.

A check box 606 is used to set whether to print the date using the transparent toner. When the user checks the check box 606, the CPU 412 sets to print, using the transparent toner, the date when printing is executed. Note that the CPU 412 acquires date data from the real-time clock module 433, and displays it on a date data display field 607.

A check box 608 is used to set whether to print the user ID of the user of the MFP 100 using the transparent toner. The CPU 412 stores, in the HDD 150, a user ID input when the user logs in to the MFP 100, and displays his user ID in a user ID display field 609.

A check box 610 is used to set whether to print an image using the transparent toner. A reference button 611 is used to select an image to be printed using the transparent toner when the user checks the check box 610. When the user presses the reference button 611, the CPU 412 causes the operation unit 140 to display a list of image data stored in the HDD 150. The user selects arbitrary image data from the displayed list. When the user selects image data, the CPU 412 displays the file name of the selected image data and the like in a text box 612.

Pull-down menus 613 and 614 are used to designate the printing format (size and inclination of a character string) of a character string when printing the character string using the transparent toner. When the user presses the pull-down menus 613 and 614, the CPU 412 displays candidates he can select.

A preview display screen 616 displays the preview of a printing result when printing using the transparent toner in accordance with contents set in the setting screen 600. The CPU 412 presents this display. The user visually checks the preview display screen 616 and can confirm the output result of a printed sheet before the start of actually printing on a sheet.

When the user finally presses an OK button 615, the CPU 412 finalizes the contents set in the respective items of the setting screen 600. Based on the setting contents, the CPU 412 generates setting data to be output to the transparent toner image generation portion 506 in FIG. 5.

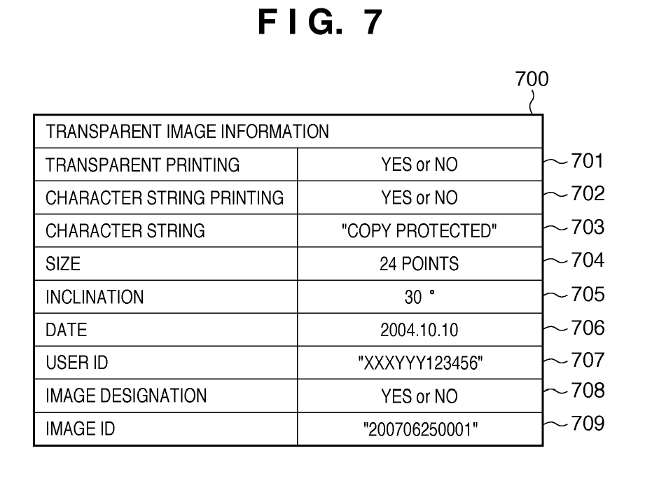

FIG. 7 is a view exemplifying finalized setting data 700. The setting data shown in FIG. 7 includes items such as “transparent printing” and “character string printing”, and their parameters. The items shown in FIG. 7 correspond to those the user can set in FIG. 6.

An item 701 is information indicating whether to print using the transparent toner. “YES” is set when it is set in the screen shown in FIG. 6 to print using the transparent toner, and “NO is set when it is set not to print using the transparent toner. If item 701 is “YES”, the CPU 412 executes printing using the transparent toner in accordance with the settings of items 702 to 708. If item 701 is “NO”, the CPU 412 does not execute printing using the transparent toner, and items 702 to 708 need not be set.

Item 702 is information indicating whether to print a character string using the transparent toner, and correspond to the settings of the check boxes 601 and 603 in FIG. 6. “YES” is set when the check box 601 or 603 is checked in the screen shown in FIG. 6, and “NO is set when neither the check box 601 nor 603 is checked. A character string is set in item 703 in correspondence with the pull-down menu 602 and text box 604 in FIG. 6. The size and inclination of the character string are set in items 704 and 705 in correspondence with pull-down menus 613 and 614.

Items 706 and 707 are pieces of information indicating whether to print a date and user ID in correspondence with the check boxes 606 and 608 in FIG. 6. Item 708 is information indicating whether to designate an image in correspondence with the check box 610 and reference button 611. An item 709 is an image ID indicating an image to be used when the image is designated. In item 709, a file path for specifying an image may be set in place of the image ID. The setting data 700 may include an item not shown in FIG. 7.

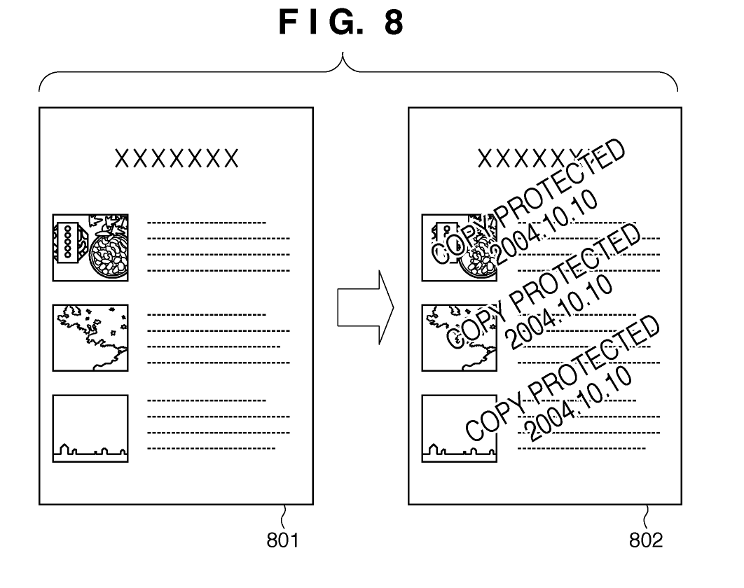

The generated setting data 700 is transmitted to the transparent toner image generation portion 506. The CPU 412 forms a toner image for the transparent toner based on the setting data, and causes the printer unit 130 to execute a printing process for the sheet. FIG. 8 is a view showing an example of a product printed by the MFP 100. In FIG. 8, an image is formed with the Y, M, C, and K color toners using image data generated by reading a document 801 by the reader unit 120. In addition, an image is formed with the transparent toner in accordance with the setting data 700. As shown in FIG. 8, a specific character string “Copy Protected” selected from the pull-down menu 602 in FIG. 6 is printed with the transparent toner on a printed product 802 output from the printer unit 130. Also, a date “2004.10.10” displayed in the date data display field in FIG. 6 is printed on the printed product 802. Note that the output result shown in FIG. 8 is merely an example, and another character string and image can also be printed in accordance with settings in the setting screen 600 shown in FIG. 6.

The following effects can be obtained by creating a printed product as described above using printing toners. For example, a product printed using the transparent toner can be guaranteed as an original. If the product (original) printed using the transparent toner is copied, the image of the transparent toner is not copied, so the copy and original can be discriminated from each other. By printing an image using the transparent toner in a specific area of an original image, the glossiness of the printing result can be adjusted at the portion where the transparent toner is attached.

Printing methods using the transparent toner are roughly classified into the following two:

(1) Method of Printing Using Transparent Toner in One Printing Process

The MFP 100 transfers and fixes an image onto a sheet by one printing process using the five, C, M, Y, K, and CL toners.

(2) Method of Printing Using Transparent Toner in Two Printing Processes

The MFP 100 transfers and fixes an image onto a sheet using the four, C, M, Y, and K color toners as the first printing process (called the first process, first printing process, or first image forming process). After the user sets again the temporarily discharged sheet in the feeding unit and inputs a printing start instruction, the MFP 100 feeds the sheet, and transfers and fixes an image onto the sheet using the CL toner as the second printing process (second process). The second process will also be called the second printing process or second image forming process.

According to method (1), all five toner images are transferred by one printing process, shortening the time taken for the printing process. However, the performance of a fixing unit restricts the amount of toner fixable at once onto one sheet. Thus, method (1) of fixing even an image of the CL toner together with those of the four, C, M, Y, and K color toners by one process has the restriction on the amount of fixable transparent toner. To the contrary, according to method (2), only an image of the transparent toner is fixed in the second process. Compared to method (1), method (2) can increase the amount of fixable transparent toner.

However, in method (2), until a sheet discharged after the first process is set in a specific feeding unit and the MFP 100 starts the second process, another print job may use the feeding unit. In this case, erroneous printing may be done by the other print job for the sheet printed in the first process. Hence, a user who executes a print job according to method (2), and one who executes another print job have to execute printing again.

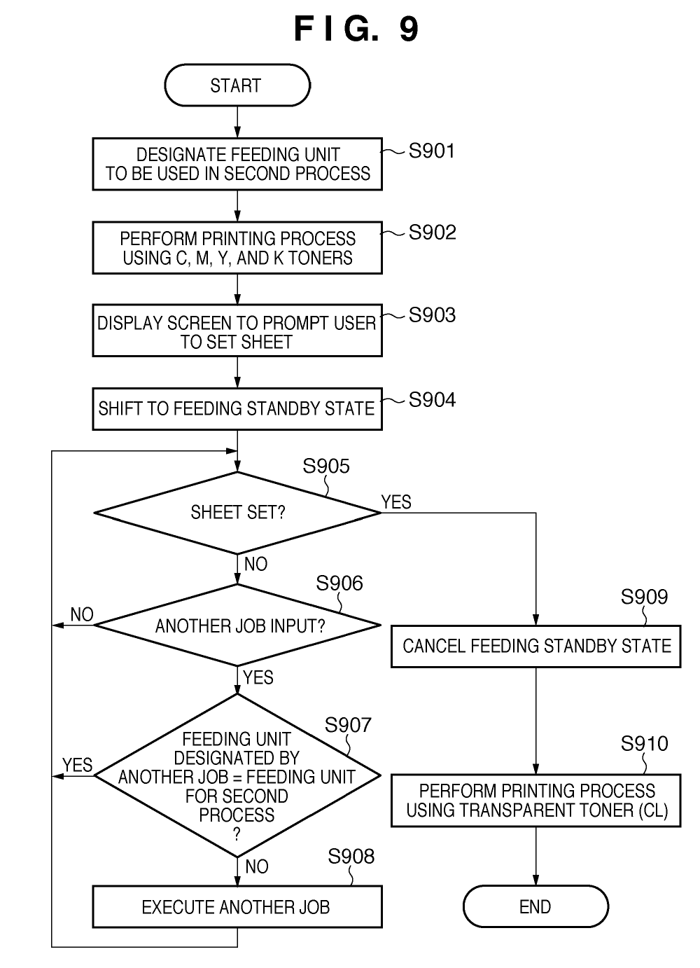

Under the circumstance, the MFP 100 according to the embodiment controls to prevent, when executing a print job including two printing processes, that is, the first and second processes mentioned above, erroneous use of a sheet in the feeding unit by another print job after executing the first process. The sequence of a printing process according to the embodiment will be explained with reference to FIG. 9. Note that the CPU 412 reads out a program stored in the ROM 414 and executing it, thereby achieving the processes of steps shown in FIG. 9.

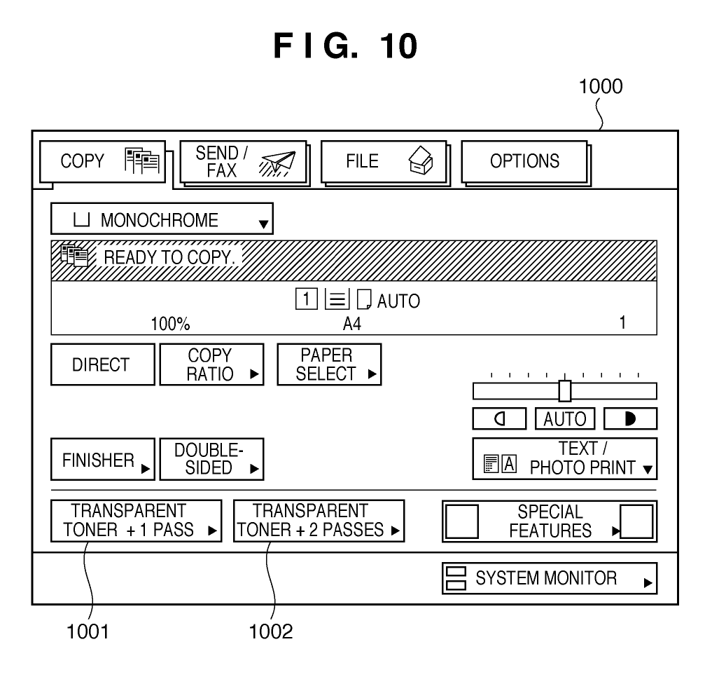

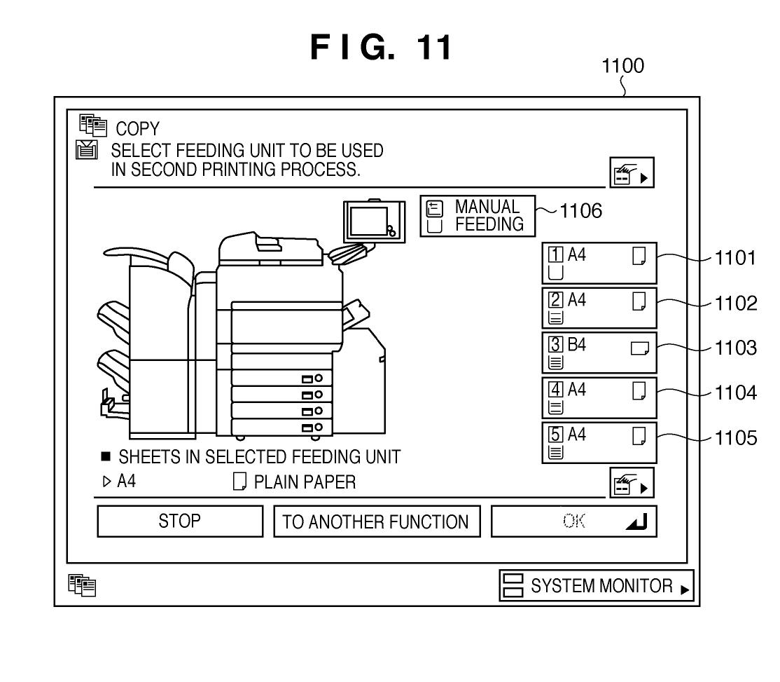

In S901, the CPU 412 displays a setting screen regarding a print job on the operation unit 140. The user makes settings regarding the print job via the setting screen. FIG. 10 shows a setting screen 1000 regarding a copy job, which is one of print jobs, as an example of the setting screen displayed on the operation unit 140. In the setting screen 1000, a button 1001 (“transparent toner+1 pass”) corresponds to method (1), and a button 1002 (“transparent toner+2 passes”) corresponds to method (2). When the CPU 412 detects that the user has pressed the button 1002, it displays, for example, a screen shown in FIG. 11 on the operation unit 140 as a setting screen for designating a feeding unit to be used in the second process out of two printing processes. In FIG. 11, buttons 1101 to 1106 corresponding to the respective feeding units of the MFP 100 are displayed. For example, the buttons 1101 to 1104 correspond to the feeding cassettes 206 to 209, the button 1105 corresponds to the feeding deck 210, and the button 1106 corresponds to the manual feeding tray 211. The user can designate a feeding unit to be used in the second process by pressing one of the buttons displayed in the setting screen. After that, the process shifts to S902. In S901, as shown in FIG. 10, the user can make various settings such as the size and type of sheet, the copy ratio, density, and monochrome/color printing as settings regarding the print job, in addition to the feeding unit to be used in the second process.

In S902, the CPU 412 executes a printing process for an image on a sheet as the first process using the four, C, M, Y, and K color toners, other than the transparent toner (CL). For example, when the CPU 412 detects that the user has pressed a start button arranged on the operation unit 140, it starts the process. After the end of the printing process, the process shifts to S903.

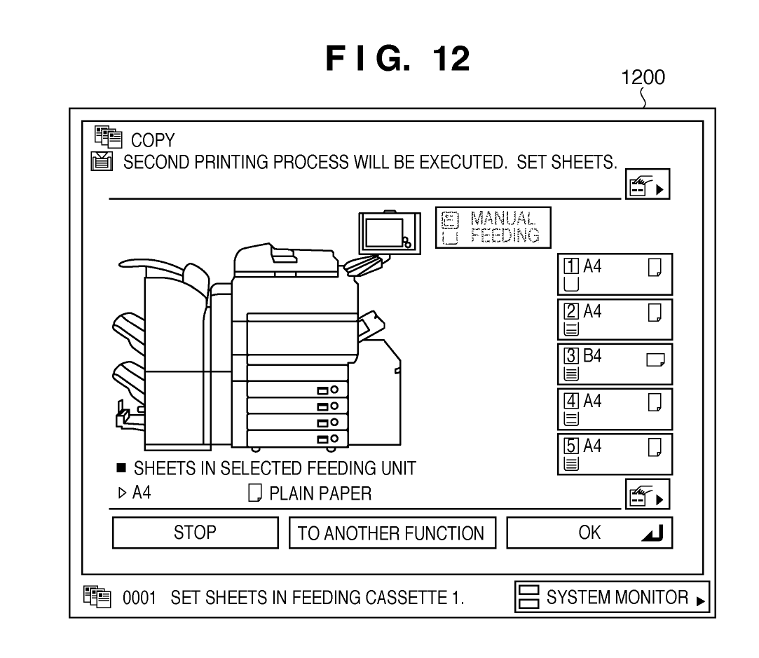

In S903, the CPU 412 displays an instruction screen 1200 in FIG. 12 on the operation unit 140 in order to instruct the user to set a sheet in the feeding unit designated in S901. From this, the user can easily confirm the feeding unit in which he is to set the sheet having the image formed in the first process. For example, when the number of pages to be processed in the first process is large, a long time is taken till the completion of the first process after the start. Especially in this case, a display as shown in FIG. 12 is effective. This display allows the user to easily recognize the feeding unit in which he is to set the sheet having the image formed in the first process, without remembering the feeding unit. In S904, the CPU 412 shifts the state of the MFP 100 to a feeding standby state, and then the process shifts to S905. In S904, the CPU 412 saves information of the print job in the HDD 150. When the user sets the sheet in the feeding unit designated for the second process of the print job, the CPU 412 can execute the saved print job. Although not shown in FIG. 12, the instruction screen 1200 may display a guidance indicating how to set the sheet (for example, face-up, face-down, or top-and-bottom direction).

In S905, the CPU 412 determines whether the user has set the sheet in the designated feeding unit. For example, when an opening/closing sensor arranged in each of the feeding cassettes 206 to 209 and feeding deck 210 detects that a corresponding feeding unit has been opened and then closed, the CPU 412 determines that the user has set the sheet in the feeding unit. As for the manual feeding tray 211, when a sheet sensor arranged in the manual feeding tray 211 detects a sheet, the CPU 412 determines that the user has set the sheet in the feeding unit.

If no sheet has been set in S905, the process shifts to S906. In S906, the CPU 412 determines whether another print job different from one in progress has been input. If no other print job has been input, the process returns to S905; if another print job has been input, shifts to S907.

In S907, the CPU 412 determines whether a feeding unit designated by the other print job is one to be used in the second process of the job in progress. If a feeding unit designated by the other print job is one to be used in the second process, the CPU 412 inhibits the other print job from performing a printing process using the feeding unit, and the process returns to S905. If a feeding unit designated by the other print job is not one to be used in the second process, the process shifts to S908. In S908, the CPU 412 allows the use of the feeding unit designated by the other print job, and executes the other print job. Upon completion of executing the job, the process returns to S905.

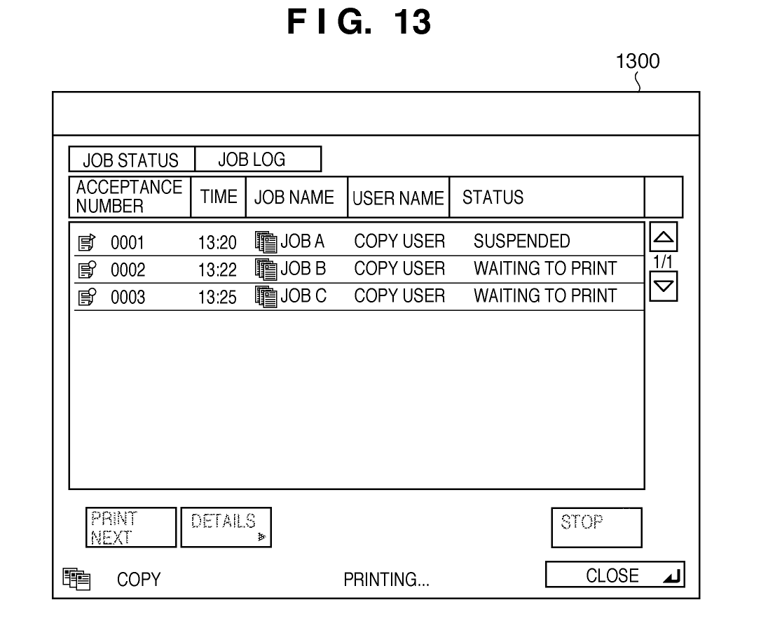

FIG. 13 exemplifies a screen that displays the status of a job input to the MFP 100. A screen 1300 displays three jobs A to C. Job A is a print job which executes two printing processes using the transparent toner according to the embodiment. Jobs B and C are normal print jobs which do not execute a printing process using the transparent toner. In FIG. 13, job A designates the feeding cassette 206 as a feeding unit to be used in the second process using the transparent toner, and stands by (“suspended”) until the user sets a sheet in the feeding cassette 206. For example, when job B designates the feeding cassette 206 and job C designates the feeding cassette 207, the CPU 412 controls to inhibit execution of job B in S907, but execute job C in S908. Instead of unconditionally inhibiting execution of job B, the CPU 412 may prompt the user to confirm whether to execute job B, and upon accepting an instruction from the user to execute job B, allow execution of job B. In this case, when the CPU 412 has not accepted an instruction from the user to execute job B, it inhibits execution of job B. In this way, the CPU 412 restricts execution of job B in S907.

If the CPU 412 determines in S905 that the user has set the sheet, the process advances to S909. The CPU 412 cancels the standby state in S909, and in S910, executes a printing process for an image on the sheet using the transparent toner (CL) as the second process. If job C is in progress, the CPU 412 controls to execute the second process after the completion of executing job C. Note that the CPU 412 restricts the use of the feeding unit, which is to be used in the second process, by another print job (for example, job B) till the start of the second process after determining in S905 that the user has set the sheet. In this example, it is controlled to automatically execute the second process when the CPU 412 determines that the user has set the sheet. However, the present invention is not limited to this, and the second process may start when the CPU 412 detects in S910 that the user has pressed the start button arranged on the operation unit 140.

After the end of the printing process in S910, the CPU 412 discharges the sheet to the discharge unit 134. When the second process starts upon detecting that the user has pressed the start button, the CPU 412 restricts the use of the feeding unit, which is to be used in the second process, by another print job till the start of the second process after the user has pressed the start button.

If another job is inhibited in S907 from using the feeding unit to be used in the second process, the time of inhibition may be limited to a predetermined one. For example, when a predetermined time has elapsed after executing the first process, the CPU 412 cancels inhibition of the use of the feeding unit by another job and allows the use of the feeding unit designated for the second process, to execute the other job. Upon the lapse of the predetermined time, if there is a running job or there is a job which has been accepted before the other job, the CPU 412 executes the other job upon completion of executing such a job. In this way, the time-out time can be set for the time by which the user needs to set a sheet in a designated feeding unit. This can prevent, for example, no execution of another job using the same feeding unit as one to be used in the second process of a given print job upon completion of executing the first process of the print job. Note that the predetermined time may be set in shipment of an image forming apparatus from the factory or by the user via the operation unit 140.

The predetermined time may be set to the time till the end of the second process. In this case, after the end of the second process, another job can quickly use the feeding unit which has been used in the second process, increasing the job processing efficiency.

As described above, the image forming apparatus according to the embodiment can obtain the following effects. When a sheet printed in the first printing process of a given print job is set in a feeding unit, the image forming apparatus can prevent the use of the sheet set in the feeding unit by another print job different from the second process of the print job.

More specifically, after the end of the first printing process, the user sets a sheet having undergone the first printing process in a feeding unit designated in advance. The image forming apparatus prevents the use of the sheet set in the feeding unit for another print job. When executing two printing processes for the same sheet, the image forming apparatus can prevent another job from erroneously using the sheet bearing an image formed in the first printing process.

In the embodiment, the first process is a printing process using the four, C, M, Y, and K colored toners, and the second process is one using the transparent toner (CL). However, the present invention is not limited to this, and is applicable to an image forming apparatus using a print job including a plurality of printing processes. For example, the present invention is applicable to a case in which the image forming apparatus performs double-sided printing as a plurality of printing processes. That is, the first process is a printing process for one surface of a sheet, and the second process is one for its other surface.

The second process is not limited to an image forming process of forming an image, and suffices to be a process to be executed for a sheet bearing an image formed in the first image forming process. The second process may be a work process such as a gloss process.

In the above-described embodiment, another print job has been exemplified as an image forming process, execution of which is restricted, but the present invention is not limited to this. For example, execution of an image forming process to form a predetermined test pattern for calibration may be restricted for a sheet fed from one of feeding units. The condition under which execution of the image forming process to form the predetermined test pattern is restricted is that a feeding unit set as the feeding source of a sheet on which the predetermined test pattern is to be formed is the same as that of the second process.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-201081, filed Aug. 31, 2009, which is hereby incorporated by reference herein in its entirety.

What is claimed is:

1. An image forming apparatus comprising:
a control unit that executes a first image forming process to form an image on a sheet fed from one of a plurality of feeding units; and
a designation unit that designates, from the plurality of feeding units, a feeding unit used for a second image forming process to be executed for the sheet having an image formed in the first image forming process executed by the control unit,
wherein when the sheet is set in the feeding unit designated by the designation unit, the control unit restricts feeding of the set sheet for an image forming process different from the second image forming process.

2. The apparatus according to claim 1, wherein when the control unit restricts feeding of the set sheet for the image forming process different from the second image forming process, the control unit feeds the set sheet for the second image forming process, and executes the second image forming process for the fed sheet.

3. The apparatus according to claim 1, wherein
when the sheet is set in the feeding unit designated by the designation unit, the control unit prompts a user to confirm whether to feed the set sheet for the image forming process different from the second image forming process, and
when the user instructs the control unit to feed the set sheet for the image forming process different from the second image forming process, the control unit allows feeding the set sheet for the image forming process different from the second image forming process.

4. The apparatus according to claim 1, wherein the control unit allows use of a feeding unit different from the feeding unit designated by the designation unit for the image forming process different from the second image forming process.

5. The apparatus according to claim 1, further comprising a display unit,
upon completion of the first image forming process, the display unit displaying a screen which instructs setting the sheet in the feeding unit designated by the designation unit.

6. The apparatus according to claim 1, wherein
the first image forming process is a process of forming an image on the sheet using a colored developing material, and
the second image forming process is a process of forming an image using a transparent developing material on the sheet having undergone the first image forming process.

7. A method of controlling an image forming apparatus, comprising:
causing a control unit to execute a first image forming process to form an image on a sheet fed from one of a plurality of feeding units; and
causing a designation unit to designate, from the plurality of feeding units, a feeding unit used for a second image forming process to be executed for the sheet having an image formed in the first image forming process executed in the causing a control unit to execute a first image forming process,
wherein in the causing a control unit to execute a first image forming process, when the sheet is set in the feeding unit designated in the causing a designation unit to designate a feeding unit, feeding of the set sheet for an image forming process different from the second image forming process is restricted.

8. A computer-readable recording medium recording a program for causing a computer to execute a method of controlling an image forming apparatus defined in claim 7.
